(19) United States
(12) Patent Application Publication
(10) Pub. No.: US 2002/0161909 A1
(43) Pub. Date: Oct. 31, 2002

(54) Synchronizing hotspot link information with non-proprietary streaming video

(76) Inventor: Jeremy White, Seattle, WA (US)

Correspondence Address: TROJAN LAW OFFICES, 9250 WILSHIRE BLVD, SUITE 325, BEVERLY HILLS, CA, 90212

(21) Appl. No.: 09/844,885

(22) Filed: Apr. 27, 2001

(51) Int. Cl. G06F 15/16

(52) U.S. Cl. 709/231; 725/112

(57) ABSTRACT

The present invention is a system and method of synchronizing hotspot link information with non-proprietary streaming video. The present invention can be used with any standard video file without modification and can be used with any standard streaming video playback application. The present invention uses a hotspot applet that is downloaded and stored in the web browser's cache to read a separate hotspot data file that is also downloaded and stored in the web browser's cache. The hotspot applet then synchronizes the hotspot data with the standard non-proprietary streaming video file. This creates a hotspot array of x-horizontal and y-vertical coordinates synchronized with the t-temporal component of the playback time for the streaming video file.

### RELATED PATENT APPLICATIONS

None.

### BACKGROUND OF THE INVENTION

1. Field of the Invention

The present invention is a system and method of synchronizing hotspot link information with non-proprietary streaming video utilizing a web browser, a hotspot applet, a hotspot data file, non-proprietary streaming video and a non-proprietary video playback program.

The Internet has become a popular medium by which people exchange and access information and communications in various digitized data forms, including text, pictures, audio and video. The medium has become so popular that it has been adapted to retrofit prior technology such as televisions though internet access devices designed to use the television screen as a monitor. These boxes are designed to be placed on the tops of televisions sets and/or near television sets and therefore have become known as “web-top boxes.”

Until recently, the average user has been limited to standard dial-up telephone access over modems for inexpensive Internet access. This telephone dial-up access is similar that of a facsimile machine connecting to another fax machine. The user connects their computer's relatively slow analog modem by way of a household telephone line to an internet service provider's receiving computer and finally on through to the larger network of computers commonly known as the Internet. This method has been limited by the technology available for standard computer modems that supply a theoretical maximum data stream of 56 thousand bytes per second (Kbps). However, this data stream is limited by line condition and connection quality. The true performance of these dial-up accounts has actually been on the order of 10 to 20 Kbps for download of any sizable data files such as streaming video. Because of these speed limitations, the quality of the streaming video experience has been very poor.

Recently there has been an increase in the availability of high-speed Internet access provided through new technologies and service mediums and a decrease in cost of using them. Digital Subscriber Lines, known by the common acronym DSL, is a modified data stream sending a digital signal over a standard telephone line that allows a user to download information at a rate up to 1.5 million bytes per second (Mbps), nearly 50 times a fast as a 28 Kbps modem. Also available though cable television service providers is another variant of high-speed data access called cable internet access. This is accessed by using a digital modem designed to connect to a cable line, the same line though which cable television data is broadcast to the television. This is equally as fast, if not faster than certain varieties of DSL. With technological advancements, access speed to the Internet will surely increase as will the speed of the internet itself.

Because of this high-speed internet access, it is now possible for average users to download large data files in a fraction of the time that was once possible. This enables users to access streaming video that has a much clearer picture and a larger playback screen than previously possible without requiring the user to have internet access through an expensive T-1, T-3 or Frame Relay line connection. Because of the availability of inexpensive high-speed internet access, the popularity of streaming video has increased and will only grow larger. Furthermore, as new compression technologies are developed and higher speed computers are available to more accurately decompress the video, internet users will eventually be able to access television quality streaming video on demand over the internet.

While initially only a few cutting-edge web site developers provided high-quality streaming video, more and more web page designers are readily incorporating streaming video into the content they provide. This is because they can be assured that more and more people will be able to access the content and make use of the value it provides. With fast internet access, streaming video enhances the internet user's experience by bringing a static web page to life. By providing video on demand, content distributors put the internet user in control.

The prior art of streaming internet video delivery can be broadly divided into two categories, standard non-interactive streaming video and interactive streaming videos, also known as hypervideo streams. Standard non-interactive streaming video is essentially an on/off experience. The user selects the streaming video they want to see, click on a hyperlink on a web page, and the video playback is initiated by the launching of a playback application. The most this method of internet video play back offers in the way of interactivity is one static hyperlink surrounding the playback application that links to new page.

To enhance the user experience while watching the playback of streaming video, software developers created a way to overlay areas that contain links to internet addresses to various other web pages and media files. These areas are known as hotspots. These are non-visible and/or visible but non-intrusive areas that are placed over an image or the streaming video player. This kind of image mapping creates an interactive experience.

Static image mapping is very common with static images, such as maps, photographs and text menus. This image mapping works by dividing the image into several quadrants, similar to a standard map coordinate system. Usually, it is the horizontal “x” and the vertical “y” planes are represented in these static image maps. By clicking on a certain area represented by the x, y coordinates, a specified action is initialed and an event occurs. This event could be the launch of a new web page, the launch of a media file, sound or video, the launch of a browser application, the launch of an electronic mail application, etc. The specific places where specific events are programmed are called hotspots. Applying these image maps and hotspots to streaming video creates a better and more enjoyable interactive experience. However to truly be interactive with the streaming video and represent the action contained in the on screen portion of the streaming video playback, a developer must also introduce a new variable to the equation, time “t.” This allows users to click on areas of the streaming video playback image and access information about the items that are displayed in the video that the media distributor wants to make available to the user at a particular time. Interactive streaming videos are truly the preferred kind of streaming videos because they create a more exciting and dynamic user experience. Interactive streaming videos enable greater value enhancement for the distributor of the streaming video by enabling the user to access extended information about the content displayed in the streaming video.

The interactive streaming videos have heretofore been available in two varieties, streaming video integrated with hotspot information (integrated hypervideo) and streaming video with a required proprietary video playback program to process a separate hotspot information database. The integrated hypervideo packages the instructions for the interactive hotspot components directly inside the streaming video file's code requiring a special software decoder component known as plug-in to decode the hotspot information and make it and the video accessible to the user. The integrated hypervideo requires that the user install a special plug-in with the user's video player in order to view the video and hotspots. There are numerous hypervideo plug-ins currently in use.

Disadvantages of using integrated hypervideo are that the streaming video will not play back, or will not play back properly, preventing the user from accessing and playing back the video file, if the user does not have the associated plug-in. This can cause the specific video playback application to fail and also cause the user's computer system to freeze up and necessitate restarting the computer. Other disadvantages to this prior art approach are: to permit an internet user to view a particular hypervideo requires that the user first determine which plug-in is needed if they do not have it; locate the internet site at which the appropriate plug-in can be downloaded; download the plug-in; sometimes pay for an upgraded version of the plug-in; install the plug-in in the user's browser; sometimes have to restart their computer system to enable the plug-in to be activated, then go back to the original web page that contained the hypervideo, access the file and hope that it works. The present invention is intended to eliminate the need for having a plug-in to decode hotspots contained in integrated hypervideo streams.

The second currently used method of overlaying hotspots in hypervideo is through the use of a proprietary customized playback application that accesses the hotspot link information from a separate hotspot database. This method requires that the video data stream be augmented with proprietary header information to initialize the proprietary playback application to access the hotspot data pool downloaded with the web page. While the data stream and the video playback stream are separate, this method requires a proprietary video player application to playback the hypervideo file. If the user does not have this application, the user will not be able to playback any of these proprietary video files.

The disadvantages to this method are numerous. If a user wants to playback the streaming hypervideo, the user must first download the proprietary video playback application and install it. This entails going to the appropriate web page hosting the video player application, downloading it, installing the application on the computer, restarting the browser and/or the computer. Further problems arise if the new video playback application associates itself with other files that were previous associated with whatever video playback application the user previously used. Installing too many different applications can also cause driver conflicts between programs on a user's computer. Finally, if the user does not have the proprietary video playback application the user can not play back the video at all. The present invention eliminates the need to install a customized video playback application to access hotspot data through a separate stream.

The present invention eliminates the above cited problems by keeping the hotspot and hyperlink data stream separate from the streaming video and utilizing any of the commonly available and widely used video playback applications. If the present invention is inoperative for any reason, the user can still view the streaming video file. The video playback will not be prevented from playing back, only the hotspot information will be disabled

### SUMMARY OF THE INVENTION

The present invention comprises a method to enable users to access interactive video files without being required to download an additional plug-in to view the streaming video in their internet web browsers. The ideal embodiment of the invention is to enable a user to access an interactive streaming video and enjoy full interactivity with the interactive streaming video if the user should desire. The interactivity of the streaming video is actuated through a unique software mini-application, known as an applet, that generates hotspot information by correlating pointing device movements and click command interaction with video frame presentation. Through this unique applet, the hotspot two-dimensional space and time coordinates information are synchronized with an industry standard streaming video playing on a standard off-the-shelf video playback application.

This allows at least two important conveniences. If for some reason the user has disabled Java in their browser or has not properly installed the Java Virtual Machine, or does not have a current web browser that supports the Java applet, the video will still play. There is no requirement to update to latest browser or video application, especially since the latest video playback applications are designed for current computer processing power and users with older computers may not have the processing power to support the latest in video playback applications. The present invention will still enable limited capability users to be able to play and enjoy the standard streaming video, even without the interactivity. If for any other reason the hotspot applet fails to activate, a user will still be able to access the web page and at least be able to enjoy the streaming video.

The following details the steps of this invention. A user enters a universal resource locator, also known as a URL in their web browser's address field or activates a link on another web page or already bookmarked in the user's browser. This sends a request to the server, which accesses the web page containing the interactive streaming video. This web page contains a command that automatically seeks out the hotspot applet from a server or the browser's applet library. On the first use, the browser downloads a hotspot applet and for subsequent uses the hotspot applet remains stored in the browser's cache. As the hotspot applet runs, it accesses the downloaded hotspot data stored in the user's computer cache. Subsequent visits to the same web page will result in the downloading of current hotspot data for all videos accessible from the web page. If the hotspot applet has been changed or updated since the last visit, the user will receive the updated information. The downloading of the hotspot data preferably occurs at the time the web page is loading.

When the user clicks on the video playback application to begin playing back the streaming video, this sends a command to the server on which the streaming video resides to send the streaming video to the user and play the streaming video. While the video is loading the hotspot applet is accessing the hotspot data file which has been downloaded to the user's computer and stored in the user's cache and begins synchronizing the hotspot data with the streaming video.

The hotspot applet reads the horizontal and vertical coordinates of the pointing device movement to retrieve hotspot hyperlink information synchronized to the video at specific times throughout the playback of the streaming video.

The web page composer can also relieve the user of the necessity of having to activate the streaming video. The web page can be written such that the streaming video will automatically load with the web page and the hotspot applet, and automatically begin playing back when loaded. This way, the user does not have to activate playback of the streaming video.

This system can also be actuated through the distribution of the hotspot applet, hotspot data files, streaming video files and web pages through alternative means including CD-ROM, DVD-ROM and wireless delivery systems. The hotspot applet can be distributed individually or packaged with other components such as web browsers, computer operating systems, computers, television “web-top” boxes, video players, personal computing devices and wireless devices such as web tablets, palm pilots and video cell phones.

Once the hotspot applet is activated, the hotspots are synchronized with the loading streaming video. Throughout te playback of the streaming video, the hotspots will change as programmed with relation to the scenes on the display. The user will be aware of the hotspots through information in the web page containing the streaming video and through the use of small frame beside the video playback screen called a MOUSESHADOW. When the user passes the pointing device icon over areas presently containing the currently active hotspot information that the user can activate, the hotspot applet will capture a frame of the playback video where the hotspot is located and place it in the smaller MOUSESHADOW screen to indicate that a hotspot is available.

By clicking on the hotspots, this activates a separate frame within the browser window called a CLICKSHADOW. The CLICKSHADOW contains the specific information and action directed by the video hotspot. Clicking on the hotspot can also instruct the streaming video to pause and remain cached at that point in playback cycle. The hotspot link will activate whatever instruction was programmed at that specific location at that point in time. Examples of instructions can include opening new browser windows, opening new frames within the same browser window, opening of graphics and/or new video files pertaining to the hotspot region, or an electronic mail application associated on the computer.

Examples of applications of this technology are endless. These examples present one graphical user interface representation. Because this invention does not require a specifically formatted graphical user interface, the interface design and layout may appear graphically different and specific layout and placement are not required. These are two examples of the application.

### EXAMPLE 1

A user watches the playback of a streaming video of a runway fashion show. The first model steps out on the runway. The user is interested in the shirt worn by the model, so the user clicks on the shirt. A hotspot is programmed over the shirt and over every item of clothing that the user is wearing. While the user hovers the pointing device over the shirt an image of the shirt appears in the MOUSESHADOW frame, the user knows there is a hotspot hyperlink available. The user can click on the model's shirt, no matter where the model is on the runway, the hypervideo has the hotspot programmed to follow the specific items of clothing. The user clicks on the shirt and information about the shirt opens up in the CLICKSHADOW frame. The user is shown the shirt and can tab through images of the shirt in a variety of colors and can select their correct size, add the item to their shopping cart and/or complete their purchase. The user goes back to the browser window with the video and hits play, and then clicks on one of the TABS that appear underneath the MOUSESHADOW frame. This particular one of the TABS said biography. The biographic information for that model opens up in the CLICKSHADOW, offering portfolio information, photographs and more hypervideo of the model wearing other designs.

### EXAMPLE 2

An internet user is watching a streaming video of a 1960's rock artists' music video. While the video is playing back the album cover can appear in the in the corner of the video and/or in the HOTSHADOW. By clicking on the album cover, purchase information opens up in CLICKSHADOW frame. This has links to electronic commerce sites where the user can purchase the album or learn more information about the artist and album prior to purchasing it. Beneath the HOTSHADOW are TABS that are labeled credits, biography, review, etc. When the user clicks on these tabs, the hyperlink opens the corresponding information in the CLICKSHADOW frame.

### BRIEF DESCRIPTION OF THE DRAWINGS

FIG. 1 is a schematic diagram of the internet connecting the content provider with the end user.

FIG. 2 is a drawing of end user's computer connected to internet.

FIG. 3 is a schematic diagram of the end user's “web top” box connected to the internet.

FIG. 4 is a schematic diagram of the interaction between user's internet receiving device and content providers assets.

FIG. 5 is a schematic diagram of one representation of the user interface for the present invention.

FIG. 6 is a diagram depicting the break down of the video into component frames and the coding process.

FIG. 7 is a flow chart of an example of operation of the user's interaction with one representation of the invention.

### DETAILED DESCRIPTION OF THE PREFERRED EMBODIMENT AND DRAWINGS

This invention is unique in that it does not require the hotspot data to be integrated into the streaming video file and the use of a plug-in to separate the hotspot data from the streaming video. Nor does the invention utilize a proprietary video player application to access a separate hotspot data stream to create the interactive hotspot experience with streaming video. This second method of hypervideo also requires that the streaming video file be modified so that it has a unique program identifying suffix and a unique header so that the that the file properly identifies the proprietary playback application. All other current hypervideo technology follows either of these two methods.

Non-proprietary streaming video is defined as standard, unmodified streaming video files of the type designed to be run on a commonly used, non-proprietary video playback application. A non-proprietary video playback application is defined a one of the commonly available, widely used and popular video playback devices including, among others, RealNetworks Real Video, Microsoft Media Player, and Apple's Quicktime.

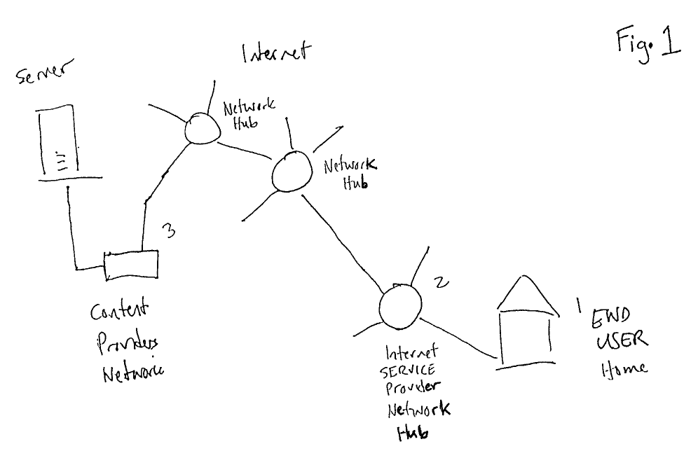

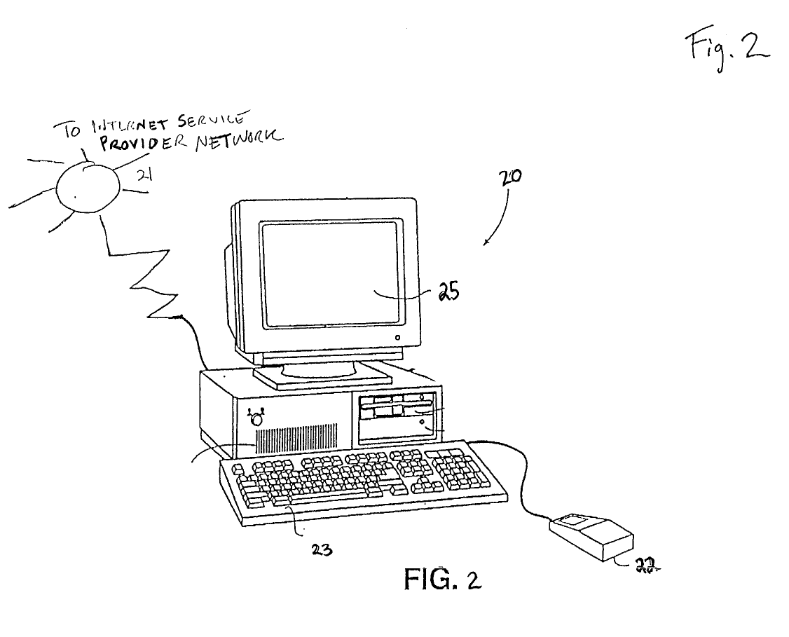

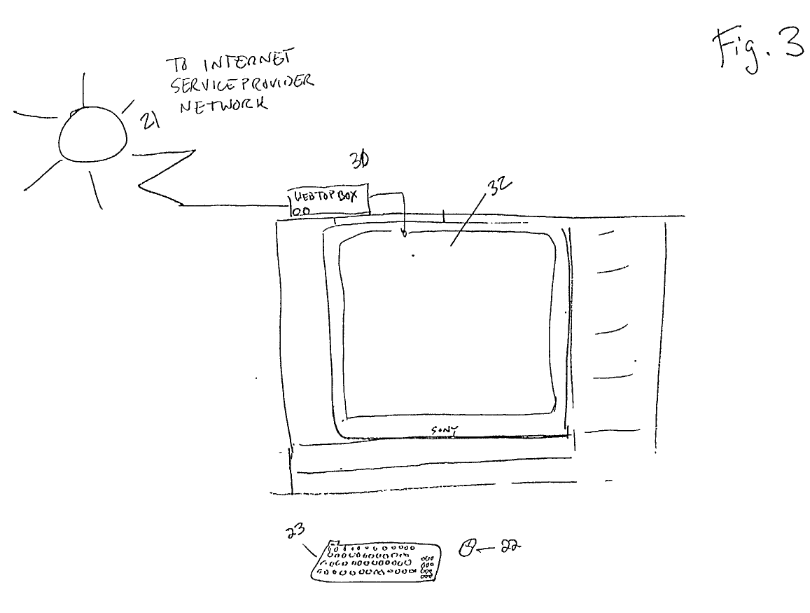

The present invention can be actuated in a variety of outward appearances but they are essentially identical in their method. FIG. 1 shows the user's home 1 connected to the Internet through their Internet service provider 2 to the content provider's network 3. FIG. 2 shows a computer 20 capable of Internet access connected to the Internet Service Provider Network 21. This computer has a mouse 22 as a pointing device, a keyboard 23 for entering typed commands, a monitor 25 for viewing the streaming video files and other computer content. FIG. 3 shows a “web top” box 30 version of the interactive hardware connected to the Internet Service Provider Network 31, the “web top” box is also connected to a television screen 32. The keyboard 23 and pointing device 22 in this configuration usually interact through the web top box via exchange of inferred signals. The computer 20 may be a desktop or a laptop computer. The computer has a modem that connects to the Internet 21 through means including digital and analog modems. The Internet connection may be indirect, through an internal network that has access to the Internet through a high-speed access line or the connection may be direct through an analog dial-up account, DSL line or digital cable modem. The Internet service may come from a telephone company, a cable company or another Internet service provider. The computer must be capable of accessing the Internet and capable of receiving and sending information over the Internet and processing information once received.

This invention can run on different computer operating systems. At this time, the only requirement is that the operating system supports the Java Virtual Machine. There are many operating systems that support the Java Virtual Machine, including Macintosh, Windows, and UNIX based systems. This invention works with many web browsing applications, including Microsoft Internet Explorer and Netscape Navigator. This invention works with many different kinds of video playback applications, including RealNetworks' Real Video, Microsoft Media Player, and Apple's Quicktime Player.

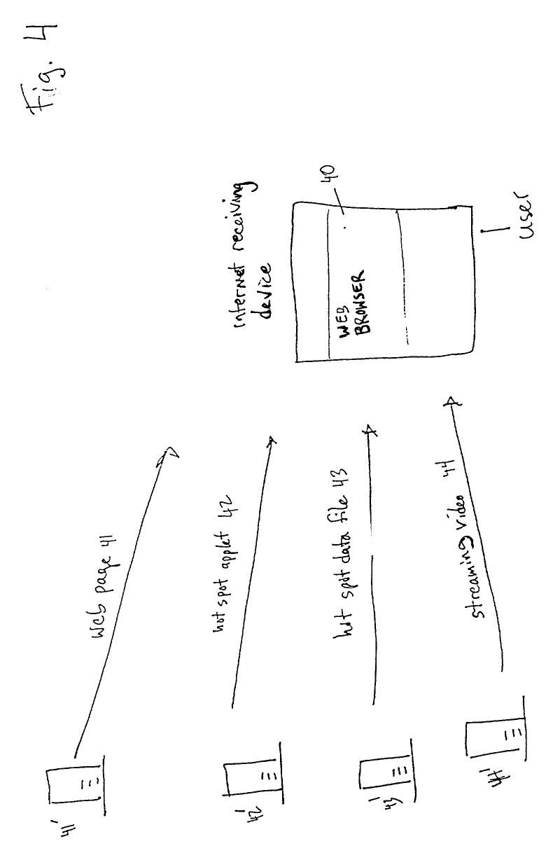

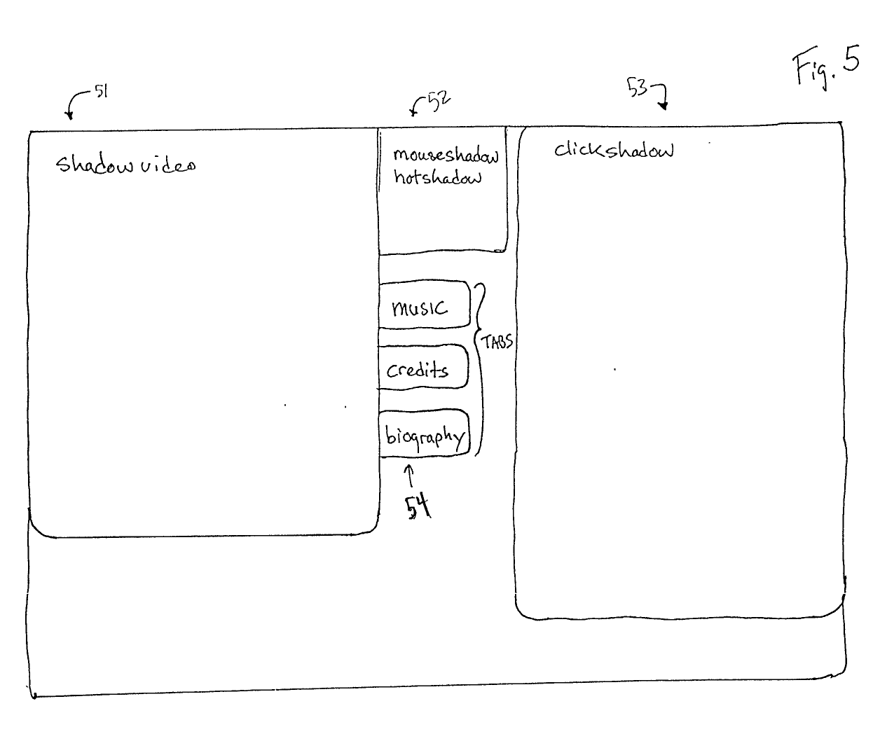

Using a standard web browsing application (shown in FIG. 4 as 40), the user accesses the web page containing the present invention. The web page 41 automatically retrieves the hotspot applet 42 through the Internet, from the server 42′ on which is stored. Similarly, the coding in the web page 41 instructs the retrieval of the hotspot data file 43 from the server on which it is stored 43′. The hotspot data file is cached on the user's computer for access and information retrieval by the hotspot applet. The web page coding also instructs the loading of a nonproprietary video playback application, the running of the hotspot applet, and the loading of the streaming video file 44 from the server on which it is stored 44′. The web page 41, hotspot applet 42, hotspot data file 43 and streaming video 44 may be stored on the same server or on different servers. Simultaneously with the loading of the streaming video the hotspot applet synchronizes the hotspot data file with the streaming video file. The streaming video with active hyperlink hotspots is called the SHADOWVIDEO (Shown in FIG. 5 as 51). The area of the browser window in which the SHADOWVIDEO is located is referred to as the SHADOWVIDEO frame. Streaming video that has been processed by this invention is said to have been SHADOWED. The graphical user interface representation of the invention places a capture window called a MOUSESHADOW and a HOTSHADOW 52 next to the SHADOWVIDEO frame 51. When a user passes the computer's pointing device, such as a mouse or pen, over an area of the video playback which corresponds to hotspot data, this MOUSESHADOW 52 will capture the target of the hotspot data so that the user may be made aware that the pointing device currently hovers over an area which corresponds with a hotspot. The MOUSESHADOW is an event indicator representing that the user has hovered over a hotspot. If there are multiple hotspots active in a video scene and they intersect with each other, only the hotspot for the hyperlink that is associated with the object in the foreground will be active. The process of resolving these hotspot conflicts is called the Z BUFFER.

When the pointing device event indicator frame shows an area where hotspots are available, this window is called a MOUSESHADOW 52. The user can then click on the hotspot underneath the pointing device icon and initiate the action directed by the hotspot data at that time and location. The resultant action can initiate an opening of information or data in another frame in the web page window. This frame containing the extended data is called a CLICKSHADOW 53. A CLICKSHADOW is an event triggered by clicking on a hotspot. A CLICKSHADOW can be any of the following: an opening of data in an new frame, an opening of a new browser window, an opening of a new web page, an opening of new multimedia files, an opening of an electronic mail application, an opening of a chat communications application, among other events.

Depending on the streaming video playback and the content, it may be more appropriate to feed the hotspot information to the user. The hotspot applet can feed the available hotspots to the capture window alerting the user that there is extended information available for the target reflected in the capture window. When the pointing device hover indicator is utilized in this manner the capture window is called a HOTSHADOW, also 52. The user can then click on the HOTSHADOW initiating a CLICKSHADOW event.

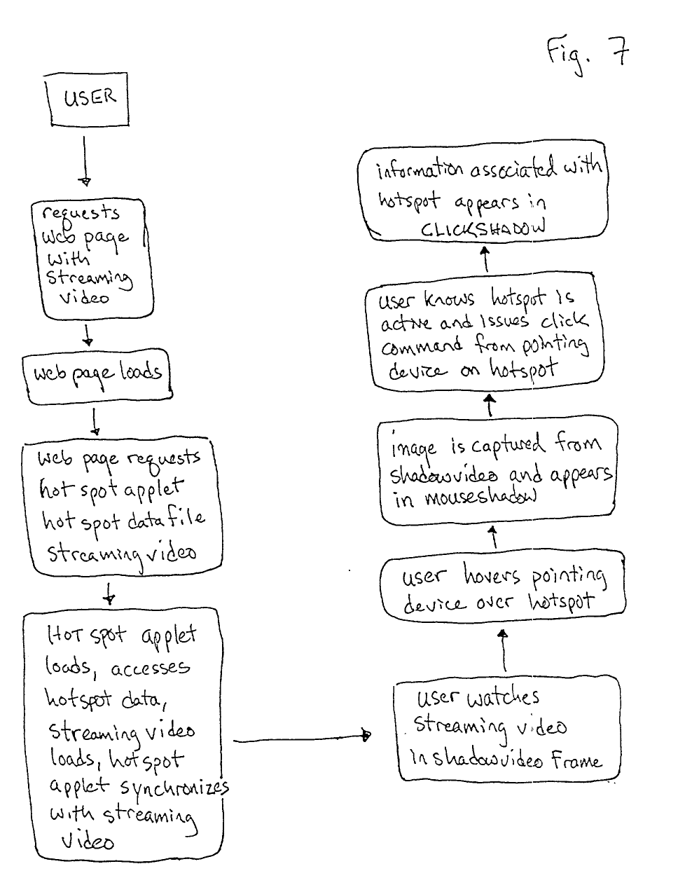

Also located beside the SHADOWVIDEO frame are TABS 54. These tabs contain hyperlinks to information that are not immediately evident in the streaming video playback itself but which may be of interest to the user. Such information that can be accessed through the TABS includes: production credits, music soundtrack information, company information, biographical information, etc. Anything that is not immediately evident can be integrated into the TABS feature. When a user clicks on one of the TABS, the resultant information will open up in the CLICKSHADOW frame. This adds greater access to extended information and further enhances the user's experience. This typical user experience is shown in FIG. 7.

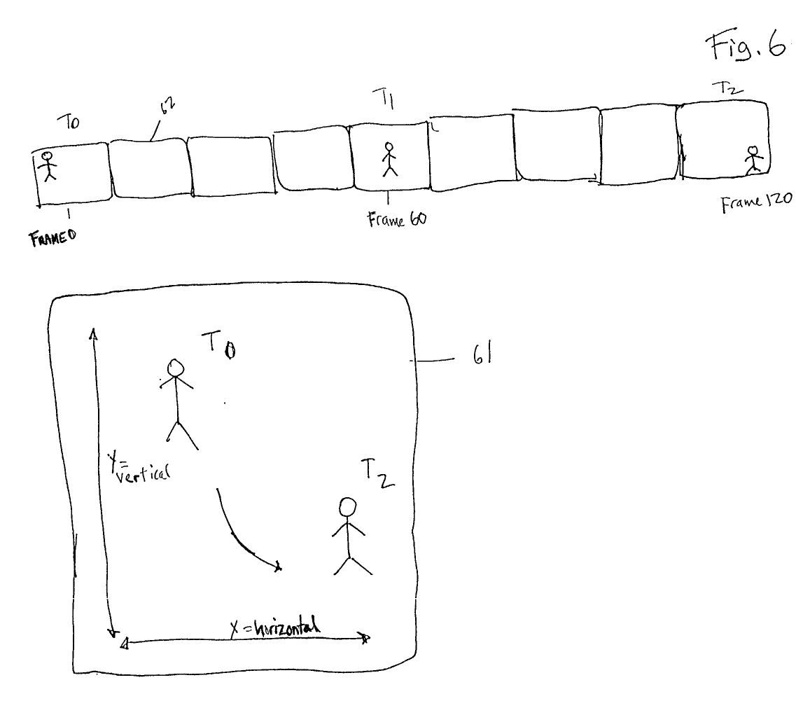

The hotspot applet ties this package together by synchronizing the hotspot data contained in the hotspot data file with the streaming video playback in the SHADOWVIDEO. The hotspot applet does this by keeping track of the playback time in the nonproprietary video file played back in the non-proprietary video player. This hotspot applet reads the pointing device cursor position at a particular time in the streaming video's playback. This is shown in FIG. 6. The video action is depicted in 61 showing the figure at T0, time zero and T2, time 2. The x, horizontal and y, vertical coordinates are depicted along the border of 61. The sequence of action is depicted in 62. The first frame in 62 is Frame 0, this is equal to time 0 or the beginning of the frame. The next frame shown in the time line is T1, time one or about 60 frames into the streaming video clip. If this video clip is playing back at a speed of 15 frames per second (fps), then the real time at T1 is 4 seconds. The next frame identified is T2, this is at frame 120 or at 8 seconds into the streaming video playback.

The hotspot applet uses a file called eclipseshadow.class to read the hotspot data file text and create an array of values corresponding to the hotspots and synchronize the hotspot data with the streaming video playback time. The hotspot applet uses the handlex.class files to adjust and tune the hotspot data to the specific video playback application. The hotspot applet uses translator files to synchronize the video playback, the video playback application and the hotspot data. The translator files are called handleX.class, where X can be substituted for whatever specific video playback applications is being used. In the case of RealNetworks' Real Video, the file would be called handlereal.class. When other video playback applications such as Microsoft Media Player or Apple Quicktime are used, the name is adjusted accordingly to instruct the hotspot applet to account for the program type.

The invention also has a studio component that enables a user to encode the hotspot data files. This studio component takes standard streaming videos for various video playback applications and breaks the streaming video file into its component frames. The user then selects key frames for encoding the hotspot data. These key frames are the video frames that are the beginning point and the end point selected for the hotspot hyperlink information. The studio component automatically interpolates the frames in between and fills in the hotspot information accordingly. During low action video sequences the key frames may be far apart, during higher action video sequences the key frames may be closer together. Thereby the hotspot information is synchronized with the streaming video playback time. While streaming video may drop frames during transmission due to network interference, the video file will have a certain length of time for playback. The hotspot applet and hotspots will remain synchronized with the playback of the streaming video.

A streaming video file is made up of many individual frames. Streaming video is essentially the same technology used for motion pictures, only in a digital format. Each individual frame is a picture from a sequence of pictures. Each second of digital streaming video is made up of a number of frames of a certain size. A generality to video production is that the larger the frame size, the higher the quality image when played back. This is because the larger the image, the more information you can have. This is the same with in the world of photography. Using a small 110 camera does not give as high a quality a print as does a comparable 35 mm film camera. More information makes the video resolution clearer. This also increases the size of the streaming video file. The larger the file the more bandwidth you use. The more bandwidth you use, the faster the Internet connection must be in order to have a good streaming video playback experience. There are also different video compression algorithms available to compress the video. However, more complex algorithms also require faster processor speeds. As programmers design better methods, streaming video quality will improve. There are numerous other variables that can be adjusted to improve video quality or decrease the size of the file, but those are not relevant to the present technology.

Streaming video usually has specific number of frames per second. The number of frames and the speed at which they appear is directly proportional to the length of a video. If you have a five minute video at 15 frames per second (fps), there will be a total number of 4500 frames in the streaming video. This calculation is 5 minutes×60 seconds/minute×15 frames/second. The number of frames equals the time depending on the number of frames per second in the streaming video. The hotspot applet uses the eclipseshadow.class file to read this time of the playback and to synchronize the horizontal and vertical hotspot information with the time of the streaming video file. The studio component allows the user to program the hotspot data file accordingly to any non-proprietary streaming video for any non-proprietary video playback application.

In this way, the studio component enables a user to associate hotspot hyperlink data with their raw video footage and other media assets. This enables the user to add enhanced value to their present video and media assets without incurring the unnecessary loss associated with adopting a proprietary distribution system. If for some reason the hotspot applet fails to work as expected, the video assets will still be available to the end user. The invention enables the user of the end product to have a better streaming video watching experience, enjoy the interactivity that the hotspot hyperlinks provide and interact with the providers of the information.

The present invention comprises an improved system and method for providing hotspot hyperlink interactivity with non-proprietary video playback applications and non-proprietary streaming video files. While the invention has been described with respect to what are presently considered to be the preferred embodiments, it is to be understood that the invention is not limited to the disclosed embodiment. Rather, the invention is intended to cover various modification and equivalent arrangements which are included within the scope and spirit of the appended claims.

I claim:

1. A method for delivering to a user's computer an interactive streaming video from a web site on the Internet comprising the following steps:
accessing said web site from said user's computer;
running a hotspot applet automatically on said user's computer when said user accesses said web site;
downloading hotspot data automatically from said web page to said user's computer, said hotspot data containing instructions for vertical, horizontal and temporal coordinates for each hotspot for streaming video that is accessible from said web site;
streaming said streaming video from said web site to said user's computer using a video playback application;
synchronizing said hotspot data with said streaming video in accordance with said vertical, horizontal and temporal coordinates using said hotspot applet; and,
whereby said user may watch said streaming video and click on hotspots without the need for installing a separate plug-in to interpret hotspot data contained in a combined video and hotspot data stream.

2. The method of claim 1, wherein the hotspot data pauses the video playback before performing designated instructions.

3. The method of claim 2, wherein said designated instructions comprise one or more of the following: open a CLICKSHADOW, open a new frame, open a new browser window, open a new web page, open new multimedia files, open an electronic mail application, open an application.

4. A system for using hotspot data synchronized with streaming video playback application comprising:
a streaming video, said streaming video played back in a video playback application;
a hotspot applet, said hotspot applet having the capability to decode said hotspot data and synchronize said hotspot data with said streaming video on playback;
said hotspot data exists as a separate file from said streaming video, to be synchronized with said Internet streaming video playback;
a web page containing links to said hotspot data, and said streaming video;

5. The system of claim 4, wherein said web page is accessed through a user's computer.

6. The system of claim 5, wherein said hotspot data corresponds to horizontal, vertical and time coordinates in said streaming video playback.

7. The system of claim 6, wherein the hotspot data pauses the video playback before performing designated instructions.

8. The system of claim 7, wherein said designated instructions comprise one or more of the following: open a new browser window, open a new web page, open new multimedia files, open an application.

9. The system of claim 4, wherein said web page automatically runs said hotspot applet, launches said video playback application, and said hotspot applet synchronizes said hotspot data for immediate use.

10. The system of claim 4, wherein said web page is accessed through a user's television Internet access device.

11. The system of claim 10, wherein said hotspot data corresponds to horizontal, vertical and time coordinates in said streaming video playback.

12. The system of claim 11, wherein the hotspot data pauses said streaming video playback before performing designated instructions.

13. The system of claim 12, wherein said designated instructions comprise one or more of the following: open a CLICKSHADOW, open a new browser window, open a new web page, open new multimedia files, open an application.

14. An application for synchronizing hotspot data with streaming video giving a user an interactive video experience comprising:
a web page containing links to a streaming video, hotspot data and a hotspot applet;
a video playback application for playing back said streaming video;
said hotspot applet, initiated at the time of the opening of said web page;
said hotspot applet reading said hotspot data and synchronizing said hotspot data with the streaming video playback designating hotspot areas;
said hotspot areas' designation based on horizontal, vertical and temporal coordinates;

15. A computer that receives streaming video and a separate hotspot data and synchronizes said hotspot data to streaming video during said streaming video playback comprising:
said computer having a pointing device capable of issuing a click command;
said computer capable of Internet access;
said computer capable of receiving a web page through said Internet;
said computer capable of receiving said streaming video through said Internet;
said computer capable of playing back said streaming video in a video playback application;
said computer capable of receiving said hotspot data contained in a text file through said Internet and storing said hotspot data text file in a cache;
said computer capable of receiving a hotspot applet through said Internet and running said hotspot applet;
said computer capable of processing said hotspot data text file on instruction from hotspot applet resulting in the synchronization of hotspot regions programmed into said hotspot data text file with said streaming video playback;
said computer capable of processing said web page, said web page containing instructions that automatically access information on loading of said web page, said information comprising said hotspot applet, said streaming video, and said hotspot data;
said computer capable of identifying the number of frames per second in said streaming video;
said computer capable of identifying the playback time of the streaming video;
said computer capable of running said hotspot applet and accessing said hotspot data text file stored on said computer in said cache and synchronizing said hotspot data with said streaming video;
said computer capable of running said hotspot applet receiving a user command from the pointing device, said command corresponding to temporal, horizontal and vertical information of said video playback;
said computer capable of performing programmed instructions associated with said hotspot when activated by said pointing device click command;

16. The computer of claim 15 comprising a desktop computer, a laptop computer, and a television based Internet access device.

17. The invention of claim 15, said computer capable of storing said hotspot applet in said web browser application's cache.

18. The invention of claim 15, said computer capable of processing said hotspot data with said hotspot applet and generating a MOUSESHADOW of said streaming video playback where said hotspot is designated whenever said pointing device passes over said area with hotspot data;

19. The invention of claim 18, said computer capable of generating a CLICKSHADOW from information contained in the hotspot data text file, said CLICKSHADOW comprising: multimedia, images, video, audio, text;

20. A method of programming hotspot data for use by a hotspot applet to synchronize the hotspot data with the streaming video playback of non-proprietary video on a non-proprietary video playback application, comprising;
deconstructing a non-proprietary streaming video file into its component frames;
selecting beginning frames at which to start the coding and groups the frames for coding relevant hyperlinks;
coding relevant hotspot data corresponding to appropriate targets contained in said component frames, said hotspot data corresponding to horizontal, vertical and temporal coordinates;
processing said selected beginning frames and said selected groups of frames to place hotspot information between the respective frames;
compiling said hotspot data into a text file readable by said hotspot applet, said hotspot applet capable of synchronizing said hotspot data with non-proprietary video playback on said nonproprietary video playback application.
